(19) United States
(12) Patent Application Publication
(10) Pub. No.: US 2019/0110001 A1
(43) Pub. Date: Apr. 11, 2019

(54) IMAGE ACQUISITION DEVICE, IMAGE PROCESSING DEVICE, IMAGE PROCESSING METHOD, IMAGE PROCESSING PROGRAM, AND IMAGE ACQUISITION SYSTEM

(71) Applicant: OLYMPUS CORPORATION, Tokyo (JP)

(72) Inventors: Takeshi FUKUTOMI, Tokyo (JP); Yukihito FURUHASHI, Tokyo (JP); Maki MATSUNAGA, Tokyo (JP)

(73) Assignee: OLYMPUS CORPORATION, Tokyo (JP)

(21) Appl. No.: 16/209,534

(22) Filed: Dec. 4, 2018

Related U.S. Application Data
(63) Continuation of application No. PCT/JP2016/069470, filed on Jun. 30, 2016.

(51) Int. Cl. H04N 5/262; G06F 3/0484; H04N 5/232; H04N 5/235

(52) U.S. Cl. CPC H04N 5/2621; H04N 5/235; H04N 5/232; G06F 3/04845

(57) ABSTRACT

An image acquisition device includes a computer configured to: acquire image data; store a plurality of parameter sets each constituted of a plurality of parameters including photographing conditions and developing conditions; obtain a change from a reference parameter for one of the parameters relating to the photographing conditions, the change being made by a user at the time of acquisition of the image data; extract and present the parameter sets involving changes in the same direction as the change in the changed parameter so as to allow the user to select one of those parameter sets in a case where the change in the parameter is obtained; and develop the acquired image data by using the parameter set selected by the user.

### CROSS-REFERENCE TO RELATED APPLICATIONS

This is a continuation of International Application PCT/JP2016/069470 which is hereby incorporated by reference herein in its entirety.

### TECHNICAL FIELD

The present invention relates to image acquisition devices, image processing devices, image processing methods, image processing programs, and image acquisition systems.

### BACKGROUND ART

There is a known type of camera with which, when photographing conditions have been specified by a user, only settings including the specified photographing conditions are extracted and presented to the user (e.g., see Patent Literature 1).

### CITATION LIST

### Patent Literature

{PTL 1}
Publication of Japanese Patent No. 4492345

### SUMMARY OF INVENTION

An aspect of the present invention is an image acquisition device including: a computer configured to: acquire image data; store a plurality of parameter sets each constituted of a plurality of parameters including photographing conditions and developing conditions; obtain a change from a reference parameter for one of the parameters relating to the photographing conditions, the change being made by a user at the time of acquisition of the image data; extract and present the parameter sets involving changes in the same direction as the change in the changed parameter so as to allow the user to select one of those parameter sets in a case where the change in the parameter is obtained; and develop the acquired image data by using the parameter set selected by the user.

Another aspect of the present invention is an image processing device including: a computer configured to: store a plurality of parameter sets each constituted of a plurality of parameters including photographing conditions and developing conditions; obtain a change, made by a user, from a reference parameter for one of the parameters; extract and present the parameter sets involving changes in the same direction as the change in the changed parameter so as to allow the user to select one of those parameter sets in a case where the change in the parameter is obtained; and develop image data by using the parameter set selected by the user.

Another aspect of the present invention is an image processing method including: obtaining a change, made by a user, from a reference parameter for one of a plurality of parameters; extracting and presenting, in a case where the change in the parameter is obtained, parameter sets involving changes in the same direction as the change in the changed parameter from among a plurality of stored parameter sets each constituted of the plurality of parameters, including photographing conditions and developing conditions; allowing the user to select one of the presented parameter sets; and developing image data by using the parameter set selected by the user.

Another aspect of the present invention is a non-transitory computer-readable medium having an image processing program stored therein, the image processing program causing a computer to execute functions of: obtaining a change, made by a user, from a reference parameter for one of a plurality of parameters; extracting and presenting, in a case where the change in the parameter is obtained, parameter sets involving changes in the same direction as the change in the changed parameter from among a plurality of stored parameter sets each constituted of the plurality of parameters, including photographing conditions and developing conditions; allowing the user to select one of the presented parameter sets; and developing image data by using the parameter set selected by the user.

Another aspect of the present invention is an image acquisition system including: an imaging device that acquires image data; and an image processing device that carries out communications with the imaging device, wherein the imaging device is configured to: store the acquired image data; and develop the stored image data, wherein the image processing device is configured to: store a plurality of parameter sets each constituted of a plurality of parameters including photographing conditions and developing conditions; obtain a change from a reference parameter for one of the parameters relating to the photographing conditions, the change being made by a user at the time of acquisition of the image data by the imaging device; and extract and present the parameter sets involving changes in the same direction as the change in the changed parameter so as to allow the user to select one of those parameter sets in a case where the change in the parameter is obtained, and wherein the imaging device is configured to develop the acquired image data by using the parameter set selected by the user via the image processing device.

Another aspect of the present invention is an image acquisition system including: an imaging device that acquires image data; a setting storage device that stores a plurality of parameter sets each constituted of a plurality of parameters including photographing conditions and developing conditions; and an image processing device that carries out communications with the imaging device and the setting storage device, wherein the imaging device is configured to: store the acquired image data and develop the stored image data, wherein the image processing device is configured to: obtain a change from a reference parameter for one of the parameters relating to the photographing conditions, the change being made by a user at the time of acquisition of the image data by the imaging device; and extract and present the parameter sets involving changes in the same direction as the change in the changed parameter so as to allow the user to select one of those parameter sets in a case where the change in the parameter is obtained, and wherein the imaging device is configured to develop the acquired image data by using the parameter set selected by the user via the image processing device.

### BRIEF DESCRIPTION OF DRAWINGS

FIG. 1 is a diagram showing the overall configuration of an image acquisition device according to an embodiment of the present invention.

FIG. 2 is a diagram showing an example of parameter sets stored in a setting storage unit of the image acquisition device in FIG. 1.

FIG. 3 is a diagram showing an example of parameter sets extracted in the image acquisition device in FIG. 1.

FIG. 4 is an illustration showing a display example presenting the extracted parameter sets in FIG. 3.

FIG. 5 is an illustration showing a display example in which one of the parameter sets has been selected in the display example in FIG. 4.

FIG. 6 is an illustration showing another display example presenting the parameter sets extracted in the image acquisition device in FIG. 1.

FIG. 7 is a diagram showing the overall configuration of a modification of the image acquisition device in FIG. 1.

FIG. 8 is a diagram showing the overall configuration of an image acquisition system according to an embodiment of the present invention.

FIG. 9 is a flowchart for explaining an image processing method executed by an image processing device included in the image acquisition system in FIG. 8.

FIG. 10 is a diagram showing the overall configuration of a modification of the image processing device included in the image acquisition system in FIG. 8.

FIG. 11 is a diagram showing the overall configuration of a modification of the image acquisition system in FIG. 8.

### DESCRIPTION OF EMBODIMENTS

An image acquisition device 1 according to an embodiment of the present invention will be described below with reference to the drawings.

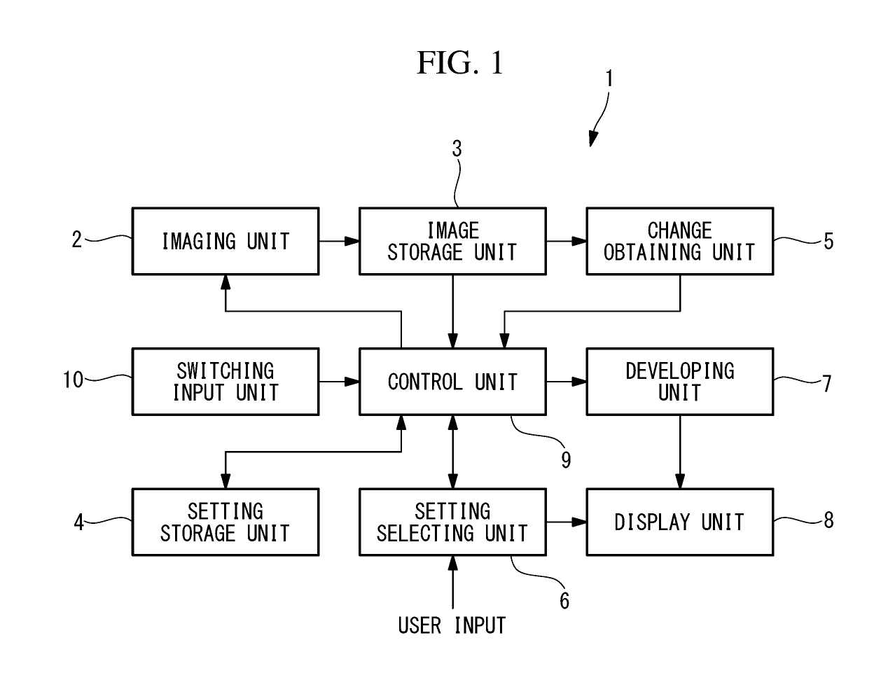

As shown in FIG. 1, the image acquisition device 1 according to this embodiment includes an imaging unit 2, an image storage unit 3, a setting storage unit 4, a change obtaining unit 5, a setting selecting unit 6, a developing unit 7, a display unit 8, and a control unit 9 that controls these components. The imaging unit 2 acquires image data of an object. The image storage unit 3 stores the image data transferred from the imaging unit 2. The setting storage unit 4 stores a plurality of parameter sets each constituted of a combination of a plurality of parameters including photographing conditions and developing conditions. The change obtaining unit 5 obtains a change in one of the parameters relating to the photographing conditions from a reference parameter, the change being made by a user at the time of acquisition of the image data by the imaging unit 2. The setting selecting unit 6 extracts and presents parameter sets involving changes in the same direction as the change in the changed parameter in the case where the parameter change has been obtained by the change obtaining unit 5, allowing the user to select one of the parameter sets. The developing unit 7 develops the image data obtained by the imaging unit 2 by using the parameter set selected by the user via the setting selecting unit 6. The display unit 8 displays an image. Furthermore, the image acquisition device 1 includes a switching input unit 10 that allows the user to perform an operation for switching the photographing conditions at the time of photographing.

The imaging unit 2 includes a photographing lens (not shown) that collects light coming from the object, and an imaging element (not shown), such as a CCD, that photographs the light collected by the photographing lens to acquire image data. The user may perform photography by using auto-setting (reference parameters) without having to operate the switching input unit 10 before photographing or may change one of the photographing conditions by operating the switching input unit 10 before photographing.

Although the change obtaining unit 5 may detect a parameter change made by operating the switching input unit 10, here, the change obtaining unit 5 is configured to detect a parameter change on the basis of a changed parameter stored in association with the acquired image data.

The setting selecting unit 6 is configured not to operate in the case where photography is performed without changing the auto-setting and to operate in the case where it is detected by the change obtaining unit 5 that the user has changed one of the parameters relating to the photographing conditions by operating the switching input unit 10.

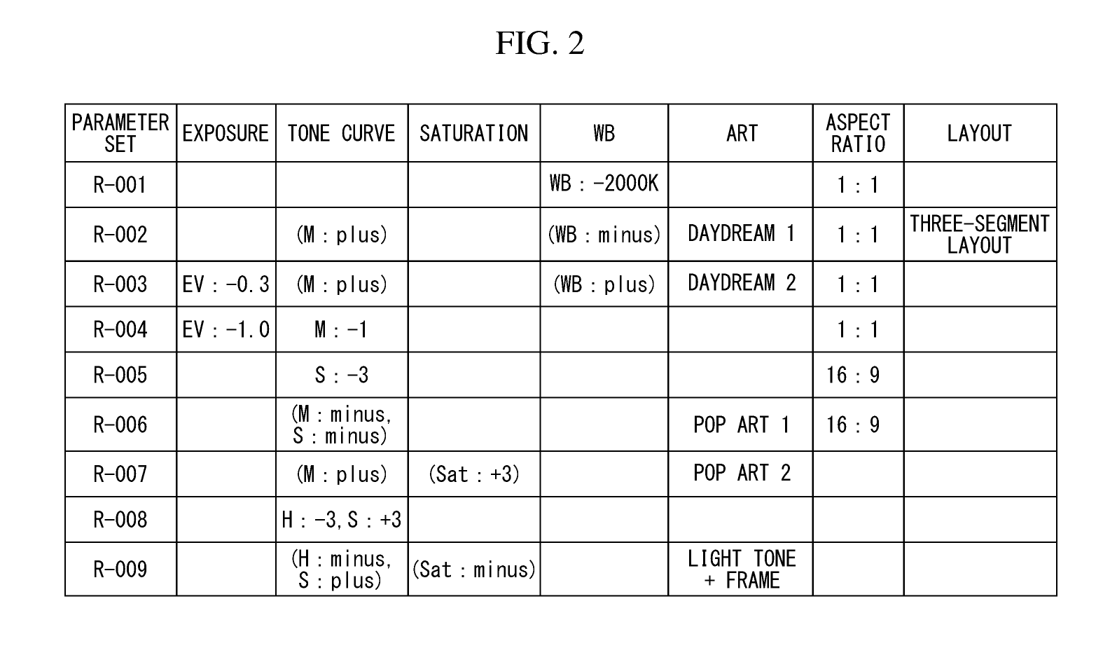

As an example, the following describes a case where a plurality of parameter sets shown in FIG. 2 are stored in the setting storage unit 4. In the example shown in FIG. 2, the leftmost column represents the name of the parameter set, the exposure and white balance (WB) are included as parameters relating to photographing conditions, and the tone curve, the saturation (Sat), the art filter (ART), the aspect ratio, and the layout are included as parameters relating to developing conditions.

Furthermore, regarding the tone curve in FIG. 2, M signifies an adjusted value in the middle section (Middle), S signifies an adjusted value in the dark section (Shadow), and H signifies an adjusted value in the bright section (Highlight).

In this case, for example, if the user performs photography while decreasing H in the tone curve by 1 from the auto-setting value, the change obtaining unit 5 detects this change, and the setting selecting unit 6 operates accordingly.

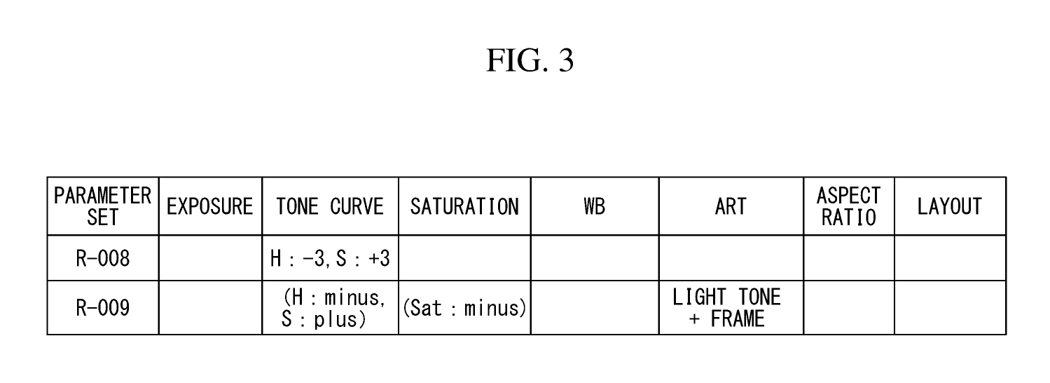

In this example, the setting selecting unit 6 is configured to extract and present R-008 and R-009, which are parameter sets involving changes in the direction of decreasing H in the tone curve, from among the parameter sets stored in the setting storage unit 4, as shown in FIG. 3.

The values of tone curves in the parameter sets presented by the setting selecting unit 6 are the values originally included in the parameter sets.

The setting selecting unit 6 is configured to present the extracted parameter sets on the display unit 8, allowing the user to select one of the parameter sets. For example, the setting selecting unit 6 is implemented in the form of a GUI.

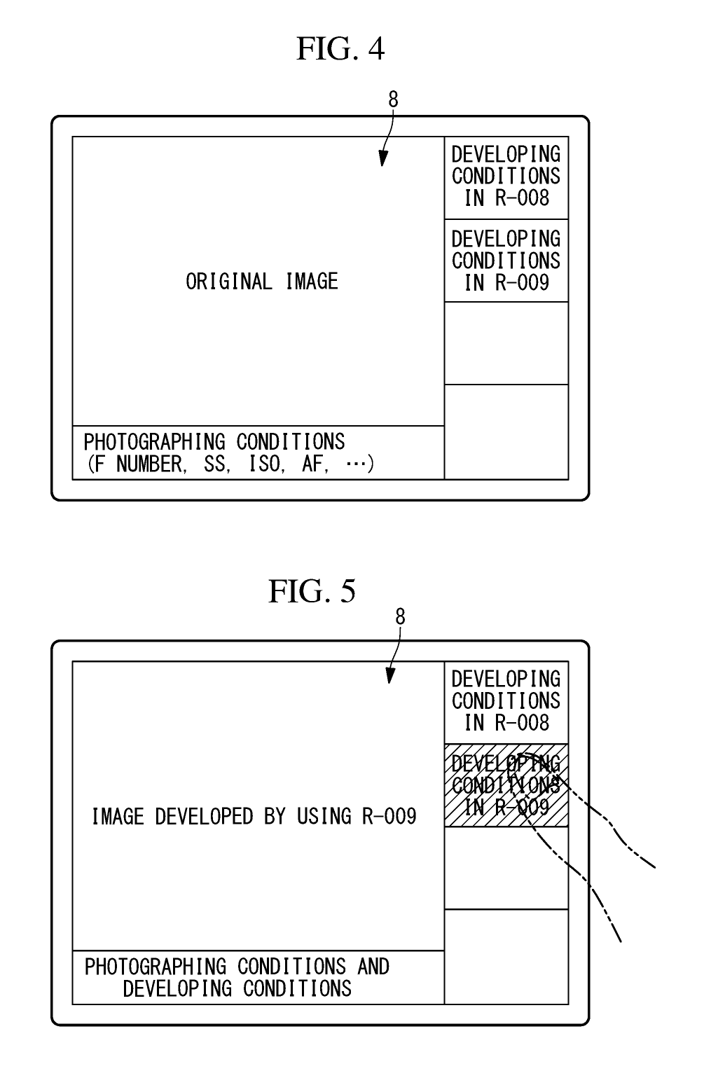

More specifically, in the case where the user changes one of the photographing conditions before performing photography, the acquired original image is displayed on the display unit 8, and the developing conditions in the parameter sets R-008 and R-009 extracted by the setting selecting unit 6 are presented on the display unit 8, as shown in FIG. 4.

The user is allowed to select one of the parameter sets presented on the display unit 8. For example, in the case where the parameter set R-009 is selected, as shown in FIG. 5, the developing unit 7 performs development by using the selected parameter set R-009, and the developed image is displayed on the display unit 8 instead of the original image. In the example described here, a parameter set is selected from the extracted parameter sets, and the developing unit 7 performs development by using the selected parameter set. Alternatively, however, a plurality of parameter sets may be selected, and development may be performed by using the plurality of parameter sets.

As another example, in the case where the user increases the saturation by +1 from the auto-setting value at the time of photographing, the parameter set R-007, which involves a change in the direction of increasing the saturation, is extracted and presented by the setting selecting unit 6.

As another example, in the case where the user decreases a color temperature of 3000 K from the auto-setting value for the white balance at the time of photographing, the parameter sets R-001 and R-002, which involve changes in the direction of decreasing the white balance, are extracted and presented by the setting selecting unit 6.

As another example, in the case where the user changes the art filter from the auto-setting to daydream 2 at the time of photographing, the parameter sets R-002 and R-003, in which the art filter is changed to daydream, are extracted and presented by the setting selecting unit 6.

As another example, in the case where the user changes the aspect ratio from the auto-setting to 16:9 at the time of photographing, the parameter sets R-005 and R-006, which involve changes in the direction of widening the aspect ratio, are extracted and presented by the setting selecting unit 6.

With the thus-configured image acquisition device 1 according to this embodiment, in the case where the user changes the photographing conditions at the time of photographing, parameter sets with which the photographing conditions are changed in the same direction are presented. Thus, in relation to the parameter changed by the user, while respecting the intent of the user, it is possible to present parameter sets involving similar intents. Accordingly, an advantage is afforded in that, in the case where a change made by the user is not precise, parameter sets involving changes in the same direction are presented, which expands the degree of freedom of selection by the user, serving to expand the range of expression.

That is, conventionally, in the case where the user changes the photographing conditions at the time of photographing, only parameter sets including photographing conditions matching the changed photographing conditions are presented. Thus, in the example in FIG. 2, for example, in the case where the user makes a change to decrease H in the tone curve by 1, no matching parameter set exist, and thus no parameter set is presented.

Accordingly, even in the case where the intention of the user is just the direction of change in the tone curve and not a precise numerical value, the user is not given an opportunity to recognize visual effects that can be added to images by adjusting other developing conditions, such as the white balance, the art filter, the aspect ratio, and the layout, in addition to adjusting the tone curve. This results in a failure to expand the range of expression.

In contrast, with the image acquisition device 1 according to this embodiment, since all the parameter sets matching the direction of change in the photographing conditions by the user are presented, the user is given an opportunity to check visual effects in images that are acquired when other developing conditions are added.

In the case where the user wishes to adopt the image displayed on the display unit 8, developed by using the selected parameter set, the user may add and store the parameter set as a favorite so that the user can read out and use the parameter set at a later occasion of photographing.

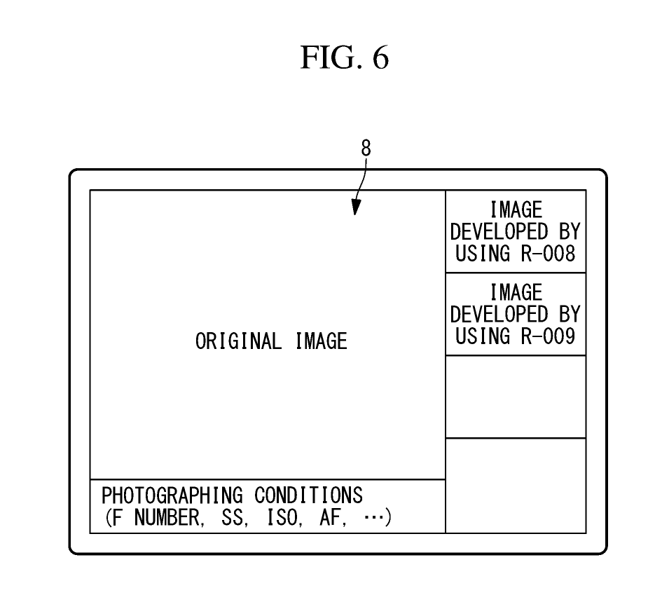

In this embodiment, regarding the parameter sets extracted by the setting selecting unit 6, the developing conditions themselves included in the parameter sets are displayed on the display unit 8. Alternatively, as shown in FIG. 6, images generated by developing the original image by using the individual parameter sets extracted by the setting selecting unit 6 may be displayed as images for selection. In this case, the user is prompted to select one of the displayed images, and the selected image is displayed in enlarged form.

Furthermore, in this embodiment, in the case where the user changes the photographing conditions at the time of photographing, regarding the parameter changed by the user, a change value in the parameter set selected by the user may be added to the value of the parameter before the change, included in the parameter set, and the resulting value may be used for development.

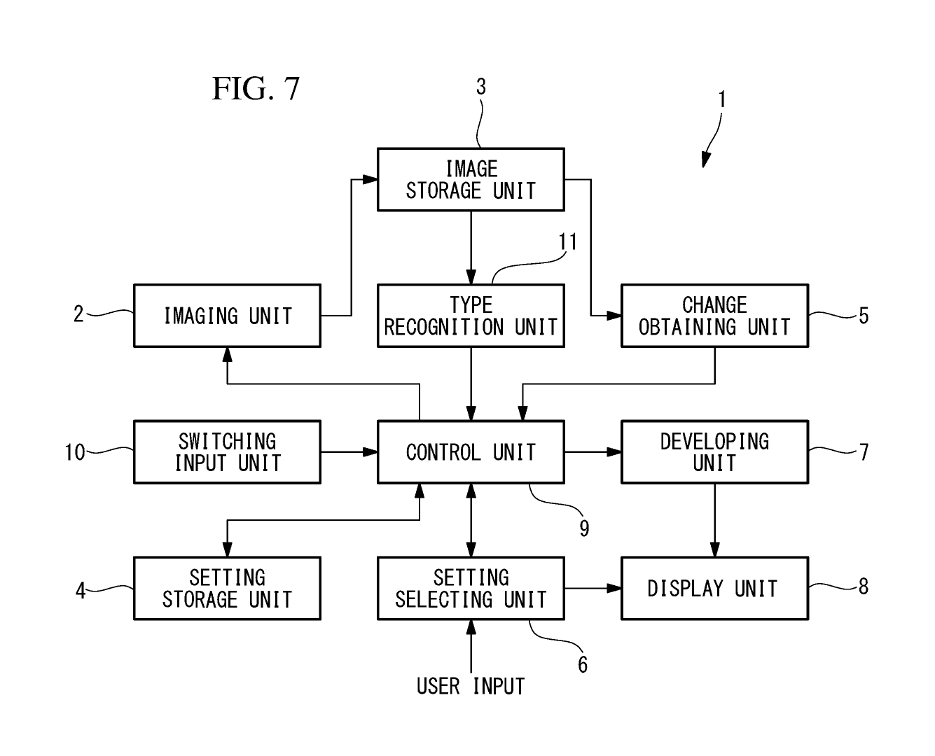

Furthermore, in this embodiment, parameter sets may be stored in the setting storage unit 4 as classified on the basis of object types or scene types. In this case, as shown in FIG. 7, a type recognition unit 11 that processes the image acquired by the imaging unit 2 to recognize the object type or scene type may be provided, and the setting selecting unit 6 may extract only the parameter sets belonging to the class matching the recognized type.

Accordingly, in the case where a large number of parameter sets are stored, parameter sets that are presented are narrowed down to parameter sets in accordance with the demand of the user, which facilitates selection.

Furthermore, although all the parameter sets extracted by the setting selecting unit 6 are presented in this embodiment, the parameter sets may be reduced at random before being presented.

Furthermore, although the exposure, the white balance, the tone curve, the saturation, the art filter, the aspect ratio, and the layout are given as examples of parameters relating to photographing conditions and developing conditions in this embodiment, other types of processing executed on image data after photographing and based on parameters having directions from auto-setting values may be adopted. Examples include edge enhancement (intensity), noise reduction (intensity), dynamic range (EV), chroma suppression (intensity), and resolution (image size).

Next, an image processing device 30, an image acquisition system 100, and an image processing method according to another embodiment of the present invention will be described below with reference to the drawings.

In the description of this embodiment, parts that are configured the same as those in the image acquisition device 1 according to the embodiment described above will be designated by the same reference signs, and descriptions thereof will be omitted.

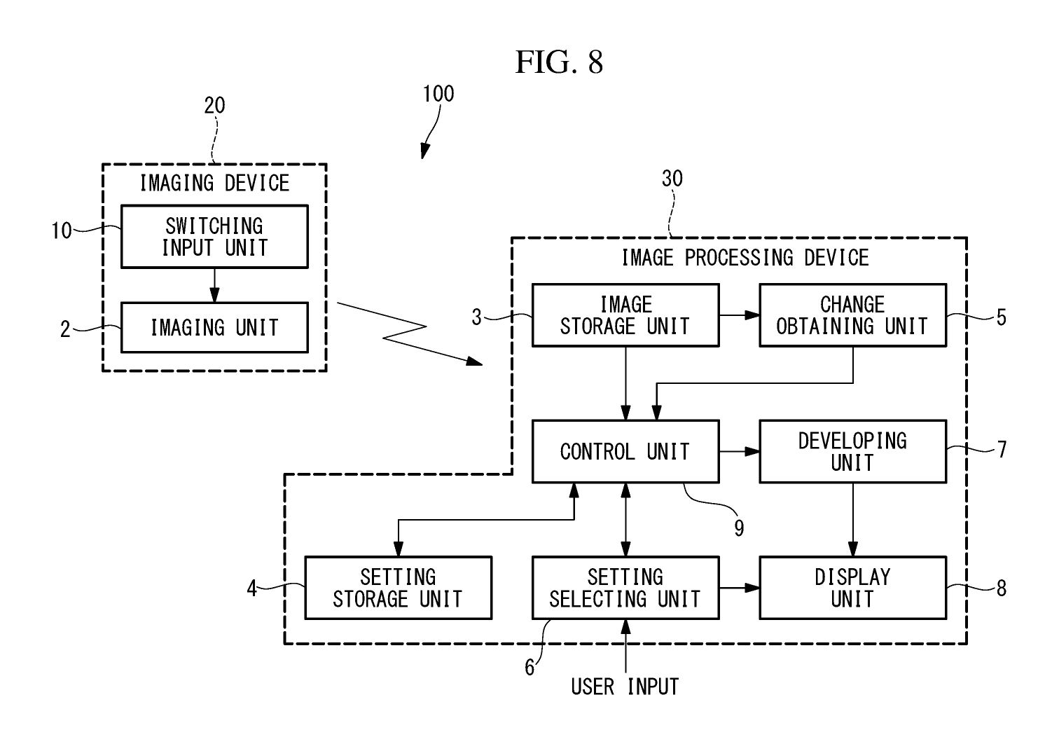

As shown in FIG. 8, the image acquisition system 100 according to this embodiment includes an imaging device 20 and an image processing device 30.

As shown in FIG. 8, the imaging device 20 includes an imaging unit 2 and a switching input unit 10 for setting photographing conditions.

Image data acquired by the imaging device 20 can be input to the image processing device 30 by way of communications or via a storage medium, in association with a photographing-condition change input via the switching input unit 10.

The image processing device 30 includes an image storage unit 3, a setting storage unit 4, a change obtaining unit 5, a setting selecting unit 6, a developing unit 7, a display unit 8, and a control unit 9. The functions of these components are the same as those in the image acquisition device 1 described above.

An image processing method using the thus-configured image processing device 30 according to this embodiment will be described below.

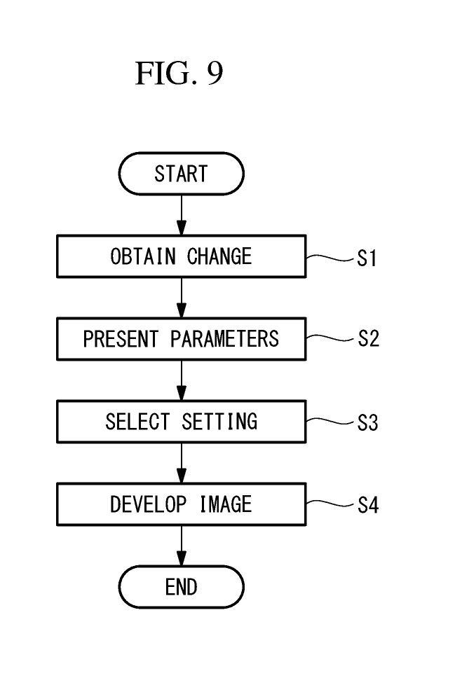

As shown in FIG. 9, the image processing method according to this embodiment includes a change obtaining step S1, a parameter presenting step S2, a setting selecting step S3, and a developing step S4.

In the change obtaining step S1, when image data associated with a change in a photographing condition is input to the image storage unit 3 by way of communications or via a storage medium, the change obtaining unit 5 obtains the change in the photographing condition at the time of photographing, associated with the image data.

In the parameter presenting step S2, parameter sets involving changes in the same direction as the parameter change made by the user are extracted from among the parameter sets stored in the setting storage unit 4, and the extracted parameter sets are presented on the display unit 8.

Then, in the setting selecting step S3, one of the parameter sets presented in the parameter presenting step S2 is selected by the user. Then, in the developing step S4, the image data is developed by using the parameter set selected by the user in the setting selecting step S3.

As described above, also with the image acquisition device 100, the image processing device 30, and the image processing method according to this embodiment, while respecting the intent of a user who has specified a photographing condition, it is possible to present parameter sets involving similar intents. Accordingly, an advantage is afforded in that it is possible to prevent the range of expression from being narrowed.

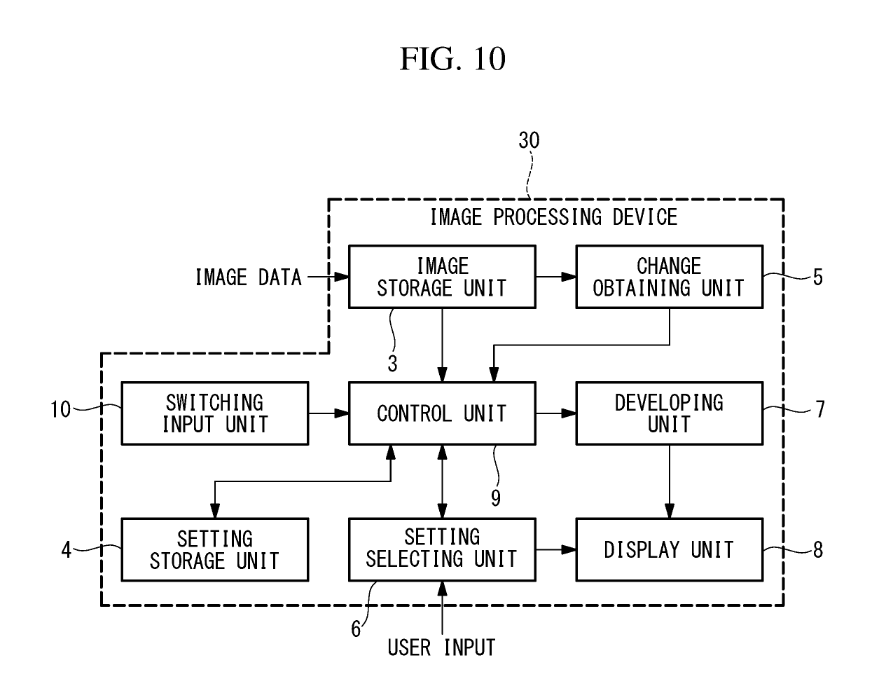

In this embodiment, in the case where the user changes a photographing condition from the auto-setting at the time of photographing by the imaging device 20, the change is detected, and the parameter sets to be presented are then extracted. Alternatively, as shown in FIG. 10, the image processing device 30 may include a switching input unit 10 for changing the photographing conditions, such as the white balance. In this case, image data acquired with the auto-setting may be received, and parameter sets may then be extracted.

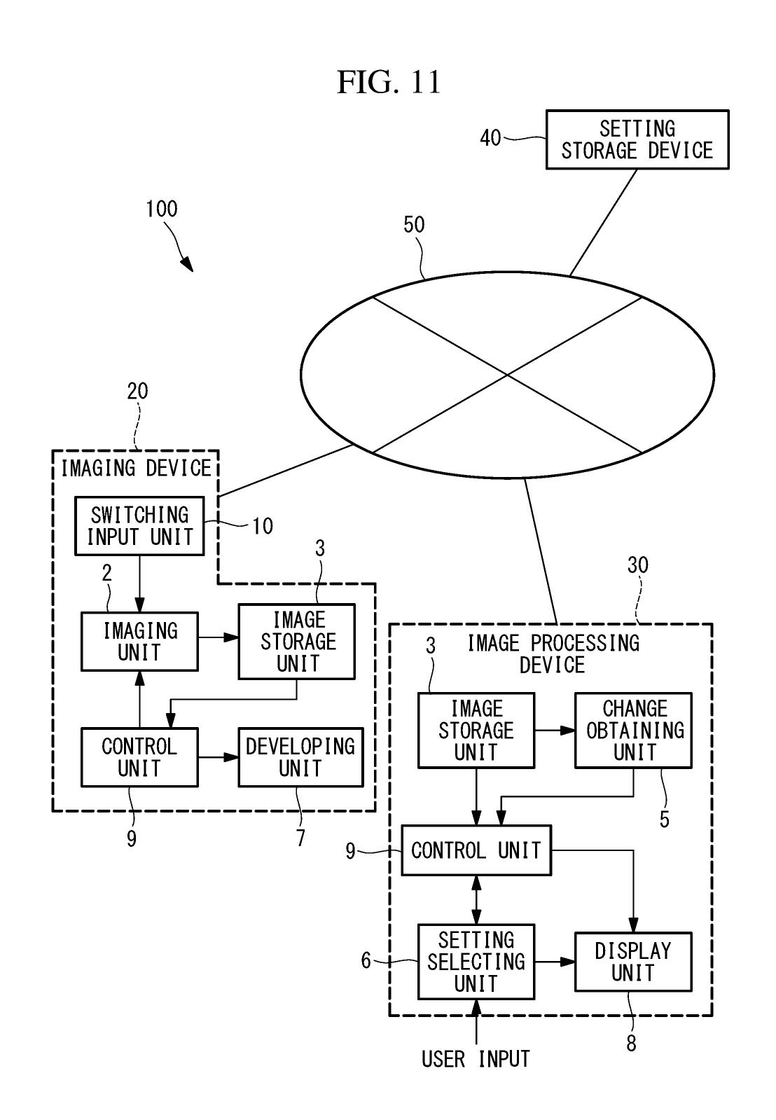

Furthermore, in the embodiment described above, the image processing device 30 includes the setting storage unit 4 that stores parameter sets and also includes the developing unit 7. Alternatively, as shown in FIG. 11, it is possible to adopt an image acquisition system 100 in which the setting storage unit 4 and the developing unit 7 are not provided in the image processing device 30, in which a setting storage device 40 that stores parameter sets is connected to the imaging device 20 and the image processing device 30 via a network 50, and in which the imaging device 20 includes the control unit 9, the image storage unit 3, and the developing unit 7.

In this case, for example, the image processing device 30 is a personal computer, a mobile terminal, or the like. The control units 9 in the imaging device 20 and the image processing device 30 are configured to control the individual components and to send and receive information via the network 50.

Large-size image data acquired at the imaging device 20 by photographing with the photographing conditions changed by the user is stored in the image storage unit 3 without being sent to the image processing device 30, and only information about the photographing conditions changed by the user, or this information together with reduced image data for display, is sent to the image processing device 30 via the network 50.

At the image processing device 30, the parameter sets extracted in the manner described above are presented on the display unit 8. When one of the parameter sets is selected by the user, the selected parameter set is sent to the imaging device 20 via the network 50. Then, the image data stored in the imaging device 20 is developed by using the received parameter set. Then, image data reduced for display is returned to the image processing device 30 and is displayed on the display unit 8.

Accordingly, it is possible to reduce the time needed for communication without having to upload large-size image data acquired by the imaging device 20 to the image processing device 30.

Furthermore, although the embodiments have been described in the context of configurations in which an image processing method is realized by hardware, the image processing method may be realized by an image processing program that can be executed by a computer. In this case, the computer includes a CPU, a main memory device such as a RAM, and a computer-readable recording medium, and an image processing program for realizing the processing described above is recorded in the recording medium. The CPU reads the image processing program recorded in the recording medium, which makes it possible to realize the same processing as the image processing device 30.

The above-described embodiment also leads to the following invention.

An aspect of the present invention is an image acquisition device including: an imaging unit that acquires image data; a setting storage unit that stores a plurality of parameter sets each constituted of a plurality of parameters including photographing conditions and developing conditions; a change obtaining unit that obtains a change from a reference parameter for one of the parameters relating to the photographing conditions, the change being made by a user at the time of acquisition of the image data by the imaging unit; a setting selecting unit that extracts and presents the parameter sets involving changes in the same direction as the change in the changed parameter so as to allow the user to select one of those parameter sets in a case where the change in the parameter is obtained by the change obtaining unit; and a developing unit that develops the image data acquired by the imaging unit by using the parameter set selected by the user via the setting selecting unit.

According to this aspect, if the user changes one of the parameters relating to photographing conditions from the reference parameter in performing photography to acquire image data by using the imaging unit, the change obtaining unit obtains the parameter change entered at the time of photographing, and the setting selecting unit extracts the parameter sets involving changes in the same direction as the obtained parameter change from among the plurality of parameter sets stored in the setting storage unit and presents the extracted parameter sets to the user. In the case where one of the presented parameter sets is selected by the user, the image data acquired by the imaging unit is developed by using the selected parameter set.

That is, by extracting the parameter sets involving changes in the same direction as the direction of change in the parameter changed by the user as parameter sets to be presented to the user, while respecting the intent of the user for the parameter changed by the user, it is possible to present parameter sets involving similar intents. Accordingly, in the case where a change made by the user is not precise, it is possible to present parameter sets involving changes in the same direction, which expands the degree of freedom of selection by the user, serving to expand the range of expression.

In the above aspect, the setting selecting unit may present images generated by developing the image data by using the extracted parameter sets.

In this case, it is possible for the user to directly confirm, before selection, the images generated by developing the image data by using the parameter sets extracted by the setting selecting unit, which facilitates selection by the user.

Furthermore, in the above aspect, the developing unit may develop the image data acquired by the imaging unit by using the parameter set selected by the user via the setting selecting unit.

In this case, it is possible to confirm visual effects in an image developed by using a parameter set stored in the setting storage unit and involving an intent similar to the intent of the user.

Furthermore, in the above aspect, the developing unit may develop the image data by using a change value by the user for the parameter changed by the user in the parameter set selected by the user via the setting selecting unit.

In this case, it is possible to confirm visual effects in an image developed by using the change value intended by the user for the parameter changed by the user among the parameter sets stored in the setting storage unit and involving intents similar to the intent of the user.

Alternatively, in the above aspect, the developing unit may develop the image data by using, for the parameter changed by the user in the parameter set selected by the user via the setting selecting unit, a value obtained by adding a change value by the user to the value of the parameter included in the parameter set.

In this case, it is possible to confirm visual effects in an image developed by using the change value enhancing the intent of the user for the parameter changed by the user among the parameter sets stored in the setting storage unit and involving intents similar to the intent of the user.

Another aspect of the present invention is an image processing device including: a setting storage unit that stores a plurality of parameter sets each constituted of a plurality of parameters including photographing conditions and developing conditions; a change obtaining unit that obtains a change, made by a user, from a reference parameter for one of the parameters; a setting selecting unit that extracts and presents the parameter sets involving changes in the same direction as the change in the changed parameter so as to allow the user to select one of those parameter sets in a case where the change in the parameter is obtained by the change obtaining unit; and a developing unit that develops image data by using the parameter set selected by the user via the setting selecting unit.

According to this aspect, the change obtaining unit obtains a change from the reference parameter for one of the plurality of parameters, and the setting selecting unit extracts only the parameter sets not involving the obtained parameter change from among the plurality of parameter sets stored in the setting storage unit and presents the extracted parameter sets to the user. In the case where one of the presented parameter sets is selected by the user, the image data acquired by the imaging unit is developed by using the selected parameter set.

That is, by extracting the parameter sets involving changes in the same direction as the direction of change in the parameter changed by the user as parameter sets to be presented to the user, while respecting the intent of the user for the parameter changed by the user, it is possible to present parameter sets involving similar intents. Accordingly, in the case where a change made by the user is not precise, it is possible to present parameter sets involving changes in the same direction, which expands the degree of freedom of selection by the user, serving to expand the range of expression.

Another aspect of the present invention is an image processing method including: a change obtaining step of obtaining a change, made by a user, from a reference parameter for one of a plurality of parameters; a parameter presenting step of extracting and presenting, in a case where the change in the parameter is obtained in the change obtaining step, parameter sets involving changes in the same direction as the change in the changed parameter from among a plurality of stored parameter sets each constituted of the plurality of parameters, including photographing conditions and developing conditions; a setting selecting step of allowing the user to select one of the parameter sets presented in the parameter presenting step; and a developing step of developing image data by using the parameter set selected by the user in the setting selecting step.

Another aspect of the present invention is an image processing program for causing a computer to execute: change obtainment processing for obtaining a change, made by a user, from a reference parameter for one of a plurality of parameters; parameter presentation processing for extracting and presenting, in a case where the change in the parameter is obtained through the change obtainment processing, parameter sets involving changes in the same direction as the change in the changed parameter from among a plurality of stored parameter sets each constituted of the plurality of parameters, including photographing conditions and developing conditions; setting selection processing for allowing the user to select one of the parameter sets presented through the parameter presentation processing; and development processing for developing image data by using the parameter set selected by the user through the setting selection processing.

Another aspect of the present invention is an image acquisition system including: an imaging device that acquires image data; and an image processing device that is capable of carrying out communications with the imaging device, wherein the imaging device includes an image storage unit that stores the acquired image data and a developing unit that develops the image data stored in the image storage unit, wherein the image processing device includes a setting storage unit that stores a plurality of parameter sets each constituted of a plurality of parameters including photographing conditions and developing conditions; a change obtaining unit that obtains a change from a reference parameter for one of the parameters relating to the photographing conditions, the change being made by a user at the time of acquisition of the image data by the imaging device; and a setting selecting unit that extracts and presents the parameter sets involving changes in the same direction as the change in the changed parameter so as to allow the user to select one of those parameter sets in a case where the change in the parameter is obtained by the change obtaining unit, and wherein the developing unit develops the image data acquired by the imaging device by using the parameter set selected by the user via the setting selecting unit.

According to this aspect, if the user changes one of the parameters relating to photographing conditions from the reference parameter in performing photography to acquire image data by using the imaging device, the photographed information is sent to the image processing device by way of communications. Then, at the image processing device, the change obtaining unit obtains the parameter change entered at the time of acquisition, and the setting selecting unit extracts the parameter sets involving changes in the same direction as the obtained parameter change from among the plurality of parameter sets stored in the setting storage unit and presents the extracted parameter sets to the user. In the case where one of the presented parameter sets is selected by the user, the image data acquired by the imaging device is developed by using the selected parameter set by the developing unit included in the imaging device.

That is, by extracting the parameter sets involving changes in the same direction as the direction of change in the parameter changed by the user as parameter sets to be presented to the user, while respecting the intent of the user for the parameter changed by the user, it is possible to present parameter sets involving similar intents. Accordingly, in the case where a change made by the user is not precise, it is possible to present parameter sets involving changes in the same direction, which expands the degree of freedom of selection by the user, serving to expand the range of expression. Furthermore, there is no need to transmit large-size image data acquired by the imaging device to the image processing device by way of communications, which serves to reduce the processing time.

Another aspect of the present invention is an image acquisition system including: an imaging device that acquires image data; a setting storage device that stores a plurality of parameter sets each constituted of a plurality of parameters including photographing conditions and developing conditions; and an image processing device that is capable of carrying out communications with the imaging device and the setting storage device, wherein the imaging device includes an image storage unit that stores the acquired image data and a developing unit that develops the image data stored in the image storage unit, wherein the image processing device includes a change obtaining unit that obtains a change from a reference parameter for one of the parameters relating to the photographing conditions, the change being made by a user at the time of acquisition of the image data by the imaging device; and a setting selecting unit that extracts and presents the parameter sets involving changes in the same direction as the change in the changed parameter so as to allow the user to select one of those parameter sets in a case where the change in the parameter is obtained by the change obtaining unit, and wherein the developing unit develops the image data acquired by the imaging device by using the parameter set selected by the user via the setting selecting unit.

According to this aspect, if the user changes one of the parameters relating to photographing conditions from the reference parameter in performing photography to acquire image data by using the imaging device, the photographed information is sent to the image processing device by way of communications. Then, the change obtaining unit of the image processing device obtains the parameter change entered at the time of acquisition. Furthermore, the image processing device reads the plurality of parameter sets stored in the setting storage device, extracts the parameter sets involving changes in the same direction as the change in the changed parameter, and presents the extracted parameter sets to the user. In the case where one of the presented parameter sets is selected by the user, the image data acquired by the imaging device is developed by using the selected parameter set by the developing unit included in the imaging device.

### REFERENCE SIGNS LIST

1 Image acquisition device
2 Imaging unit
3 Image storage unit
4 Setting storage unit
5 Change obtaining unit
6 Setting selecting unit
7 Developing unit
20 Imaging device
30 Image processing device
40 Setting storage device
S1 Change obtaining step
S2 Parameter presenting step
S3 Setting selecting step
S4 Developing step

1. An image acquisition device comprising:
a computer configured to:
acquire image data;
store a plurality of parameter sets each constituted of a plurality of parameters including photographing conditions and developing conditions;
obtain a change from a reference parameter for one of the parameters relating to the photographing conditions, the change being made by a user at the time of acquisition of the image data;
extract and present the parameter sets involving changes in the same direction as the change in the changed parameter so as to allow the user to select one of those parameter sets in a case where the change in the parameter is obtained; and
develop the acquired image data by using the parameter set selected by the user.

2. The image acquisition device according to claim 1, wherein the computer is configured to present images generated by developing the image data by using the extracted parameter sets.

3. The image acquisition device according to claim 1, wherein the computer is configured to develop the acquired image data using the parameter set selected by the user.

4. The image acquisition device according to claim 1, wherein the computer is configured to develop the image data by using a change value by the user for the parameter changed by the user in the parameter set selected by the user.

5. The image acquisition device according to claim 1, wherein the computer is configured to develop the image data by using, for the parameter changed by the user in the parameter set selected by the user, a value obtained by adding a change value by the user to the value of the parameter included in the parameter set.

6. An image processing device comprising:
a computer configured to:
store a plurality of parameter sets each constituted of a plurality of parameters including photographing conditions and developing conditions;
obtain a change, made by a user, from a reference parameter for one of the parameters;
extract and present the parameter sets involving changes in the same direction as the change in the changed parameter so as to allow the user to select one of those parameter sets in a case where the change in the parameter is obtained; and
develop image data by using the parameter set selected by the user.

7. An image processing method comprising:
obtaining a change, made by a user, from a reference parameter for one of a plurality of parameters;
extracting and presenting, in a case where the change in the parameter is obtained, parameter sets involving changes in the same direction as the change in the changed parameter from among a plurality of stored parameter sets each constituted of the plurality of parameters, including photographing conditions and developing conditions;
allowing the user to select one of the presented parameter sets; and
developing image data by using the parameter set selected by the user.
